(19) United States
(12) Patent Application Publication
(10) Pub. No.: US 2024/0260157 A1
(43) Pub. Date: Aug. 1, 2024

(54) LIGHTING SYSTEM AND METHOD FOR MANAGING LIGHTING IN ENVIRONMENT

(71) Applicant: Digitectura Technologies Pvt. Ltd, Bengaluru (IN)

(72) Inventors: Murugavelu Thangavelu, Sunnyvale, CA (US); Harish Kumar Muni Byrappa, Bengaluru (IN)

(73) Assignee: Digitectura Technologies Pvt. Ltd, Bengaluru (IN)

(21) Appl. No.: 18/300,074

(22) Filed: Apr. 13, 2023

(30) Foreign Application Priority Data
Jan. 31, 2023 (IN) 202341006299

(51) Int. Cl. H05B 47/11; H05B 47/115

(52) U.S. Cl. CPC H05B 47/11; H05B 47/115

(57) ABSTRACT

Present disclosure provides a fixed lighting system and method for managing lighting in a closed environment for optimal work condition/living condition. The lighting system includes multiple illumination sources and a lighting management device connected to an illumination source through a lighting driver. The lighting management device includes an illumination sensor manager to determine a lighting condition parameter based on a lighting condition of the environment and an occupancy sensor manager to determine an occupancy parameter based on an occupancy in a predefined area of the environment. A light controller to receive the lighting condition parameter, the occupancy parameter and a lighting driver state, and determine an optimum level of illumination intensity and an optimum level of illumination color for the predefined area of the environment and a lighting driver controller to manage the lighting conditions of the predefined area of the environment.

### PRIORITY DETAILS

The present application is based on, and claims priority from an Indian Application Number 202341006299 filed on 31 Jan. 2023, the disclosure of which is hereby incorporated by reference herein.

### FIELD

The embodiments herein relate to lighting management. More particularly relates to a lighting system and method for managing lighting in an environment using multiple lighting management devices associated with individual illumination sources.

### BACKGROUND

In general, energy consumption of large areas such as for example corporate offices, educational institutions, exhibition areas, tech parks, etc., are high due to inefficient use of energy. The large areas may have multiple devices such as lighting systems, air conditioning systems, work stations, large power back-up systems, etc., which consume large amount of energy. It may be noted that lighting load contributes significantly to the energy consumption in the large areas. In many situations the lighting systems may not be required due to the presence of ample natural light, but there is no mechanism to change the lighting control efficiently.

Over the last decade multiple control systems have been developed to increase efficiency of usage of the lighting systems by decreasing operational time. Also, in many existing lighting systems, a single light sensor provided say close to a window pane is connected to a control system. The control system receives input from the single light sensor to control the lighting systems. Here, the system is not a closed loop and has no real-time control. Further, a lot of manual work needs to be done during installation and commissioning process to arrive at approximate input to the control system. Since the control system considers only the input received from the single light sensor, the lighting system is not efficient in energy management. Thus, it is desired to address the above-mentioned disadvantages or other shortcomings or at least provide a useful alternative.

### SUMMARY

Accordingly, the embodiments herein provide a lighting system for managing lighting in an environment. The lighting system includes a plurality of illumination sources in the environment and a lighting management device of a plurality of lighting management devices connected to an illumination source of the plurality of illumination sources through the lighting driver. Each illumination source comprises a lighting driver. The lighting management device includes at least one illumination sensor manager configured to determine a lighting condition parameter associated with the environment based on lighting conditions of the environment. The lighting conditions of the environment is determined by at least one illumination sensor connected to the at least one illumination sensor manager. The lighting management device also includes at least one occupancy sensor manager configured to determine an occupancy parameter based on occupancy in a predefined area of the environment. The occupancy in the predefined area of the environment is determined by at least one occupancy sensor connected to the at least one occupancy sensor manager. The lighting management device also includes a light controller configured to receive at least one of: the lighting condition parameter, the occupancy parameter and a lighting driver state, and determine an optimum level of illumination intensity and an optimum level of illumination color for the predefined area of the environment based on at least one of: the lighting condition parameter, the occupancy parameter and the lighting driver state. The lighting driver state indicates at least one of a current lighting condition of the predefined area and a lighting management capability of a lighting driver associated with an illumination source. The lighting management device also includes a lighting driver controller configured to manage the lighting conditions of the predefined area of the environment using the lighting driver associated with the illumination source, based on the optimum level of illumination intensity and the optimum level of illumination color. The lighting driver controller is connected to the light controller and the lighting driver associated with the illumination source.

In an embodiment, at least one illumination sensor manager is configured to determine the lighting condition parameter associated with the environment based on the lighting conditions of the environment includes determine at least one of: illumination intensity and illumination color in the predefined area of the environment based on the lighting conditions, wherein the predefined area of the environment is illuminated by at least one of: the illumination source associated with the predefined area, at least one illumination source associated with at least one neighboring area of the predefined area and natural light; and determine the lighting condition parameter using at least one of: the illumination intensity and the illumination color in the predefined area of the environment.

In an embodiment, the light controller is configured to determine the optimum level of illumination intensity and the optimum level of illumination color for the predefined area of the environment based on at least one of: the lighting condition parameter, the occupancy parameter and the lighting driver state includes determine that the illumination intensity of the lighting condition parameter does not meet an illumination intensity threshold and determine that the illumination color of the lighting condition parameter does not meet an illumination color requirement. The illumination intensity threshold is determined based on a minimum illumination required for the predefined area and a maximum illumination provided to the predefined area. The light controller is configured to determine the optimum level of illumination intensity and the optimum level of illumination color for the predefined area of the environment based on at least one of: the lighting condition parameter, the occupancy parameter and the lighting driver state.

In an embodiment, the lighting driver controller configured to manage the lighting conditions of the predefined area of the environment using the lighting driver associated with the illumination source, based on the optimum level of illumination intensity and the optimum level of illumination color includes receive the optimum level of illumination intensity and the optimum level of illumination color for the predefined area and determine a plurality of parameters associated with the lighting driver that is connected to the illumination source. The lighting driver controller configured to determine whether an occupancy state in the predefined area based on the occupancy parameter is occupied and perform one of: configure the lighting driver with the determined plurality of parameters associated with the lighting driver and manage the lighting conditions of the predefined area of the environment by modifying the illumination source using the configured lighting driver, in response to determining that the occupancy state in the predefined area based on the occupancy parameter is occupied, and switch of the lighting driver, in response to determining that the occupancy state in the predefined area based on the occupancy parameter is not occupied.

In an embodiment, the lighting system further comprises an aggregator configured to send at least one of: the lighting condition parameter associated with the environment, the occupancy parameter and the lighting driver state to a cloud server and receive energy management report from the cloud server, wherein the energy management report is generated by the cloud server based on at least one of: the lighting condition parameter associated with the environment, the occupancy parameter and the lighting driver state.

Accordingly, the embodiments herein provide a method for managing lighting in an environment by a lighting system. The method includes determining, by a lighting management device of a plurality of lighting management devices, lighting condition parameter associated with the environment based on a lighting conditions of the environment and determining, by the lighting management device, an occupancy parameter based on occupancy in a predefined area of the environment. The method also includes receiving, by the lighting management device, at least one of: the lighting condition parameter, the occupancy parameter and a lighting driver state and determining, by the lighting management device, an optimum level of illumination intensity and an optimum level of illumination color for the predefined area of the environment based on at least one of: the lighting condition parameter, the occupancy parameter and the lighting driver state. The lighting driver state indicates at least one of a current lighting condition of the predefined area and a lighting management capability of a lighting driver associated with an illumination source. Further, the method includes managing, by the lighting management device, the lighting conditions of the predefined area of the environment using the lighting driver associated with the illumination source, based on the optimum level of illumination intensity and the optimum level of illumination color.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

### BRIEF DESCRIPTION OF THE FIGURES

This embodiment is illustrated in the accompanying drawings, throughout which like reference letters indicate corresponding parts in the various figures. The embodiments herein will be better understood from the following description with reference to the drawings, in which:

FIG. 1 is a block diagram of a lighting management device of a lighting system for managing lighting in an environment, according to an embodiment as disclosed herein;

FIG. 2 is a flow chart illustrating a method for managing lighting in an environment by the lighting system, according to an embodiment as disclosed herein;

FIG. 3A illustrates the lighting system for managing the lighting in an office environment, according to prior art;

FIG. 3B illustrates the lighting system for managing the lighting in the office environment, according to an embodiment as disclosed herein;

FIG. 4A is an example illustrating the lighting system for managing the lighting in a work area, according to an embodiment as disclosed herein;

FIG. 4B is an example illustrating the lighting system for managing the lighting in a home area, according to an embodiment as disclosed herein;

FIG. 5 is an example illustrating the lighting system for managing the lighting in a large corporate office with multiple cubicles, according to an embodiment as disclosed herein; and

FIG. 6A-6B are flow charts illustrating step-by-step process for managing the lighting in the environment by the lighting system, according to an embodiment as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, the embodiments herein provide a lighting system for managing lighting in an environment. The lighting system includes a plurality of illumination sources in the environment and a lighting management device of a plurality of lighting management devices connected to an illumination source of the plurality of illumination sources through the lighting driver. Each illumination source comprises a lighting driver. The lighting management device includes at least one illumination sensor manager configured to determine a lighting condition parameter associated with the environment based on a lighting condition of the environment. The lighting conditions of the environment is determined by at least one illumination sensor connected to the at least one illumination sensor manager. The lighting management device also includes at least one occupancy sensor manager configured to determine an occupancy parameter based on occupancy in a predefined area of the environment. The occupancy in the predefined area of the environment is determined by at least one occupancy sensor connected to the at least one occupancy sensor manager.

The lighting management device also includes a light controller configured to receive at least one of: the lighting condition parameter, the occupancy parameter and a lighting driver state, and determine an optimum level of illumination intensity and an optimum level of illumination color for the predefined area of the environment based on at least one of: the lighting condition parameter, the occupancy parameter and the lighting driver state. The lighting driver state indicates at least one of a current lighting condition of the predefined area and a lighting management capability of a lighting driver associated with an illumination source. The lighting management device also includes a lighting driver controller configured to manage the lighting conditions of the predefined area of the environment using the lighting driver associated with the illumination source, based on the optimum level of illumination intensity and the optimum level of illumination color. The lighting driver controller is connected to the light controller and the lighting driver associated with the illumination source.

Accordingly, the embodiments herein provide a method for managing lighting in an environment by a lighting system. The method includes determining, by a lighting management device of a plurality of lighting management devices, lighting condition parameter associated with the environment based on a lighting condition of the environment and determining, by the lighting management device, an occupancy parameter based on occupancy in a predefined area of the environment. The method also includes receiving, by the lighting management device, at least one of: the lighting condition parameter, the occupancy parameter and a lighting driver state and determining, by the lighting management device, an optimum level of illumination intensity and an optimum level of illumination color for the predefined area of the environment based on at least one of: the lighting condition parameter, the occupancy parameter and the lighting driver state. The lighting driver state indicates at least one of a current lighting condition of the predefined area and a lighting management capability of a lighting driver associated with an illumination source. Further, the method includes managing, by the lighting management device, the lighting conditions of the predefined area of the environment using the lighting driver associated with the illumination source, based on the optimum level of illumination intensity and the optimum level of illumination color.

In the conventional methods and lighting systems, a single light sensor provided close to a window pane is connected to a control system and the control system controls the lighting in the environment based on the input from the single light sensor. However, the lighting systems are not closed loop and have no real-time control.

The conventional methods and lighting systems which use the single light sensor requires a lot of manual work during installation and commissioning process to be able to arrive at approximate input to the control system.

The conventional methods and lighting systems which use the single light sensor is not very efficient in energy management as the control system considers only the input received from the single light sensor.

Unlike to the conventional methods and systems, the proposed method includes providing a lighting management device connected to the light driver of each of the illumination source. The lighting management device determines an optimum illumination intensity and illumination color based on the ambient light in the environment and also considering the light from neighboring illumination sources along with occupancy state in the predefined area.

Unlike to the conventional methods and systems, the proposed method includes using different sensors which provide data about occupancy, natural light availability and scheduling of the light based on operational time of the large areas.

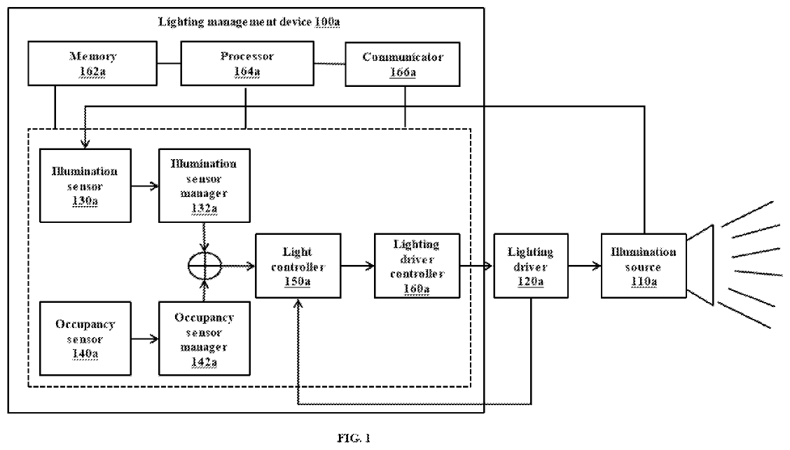

Referring now to the drawings, and more particularly to FIGS. 1 through 6B, where similar reference characters denote corresponding features consistently throughout the figures, there are shown preferred embodiments.

FIG. 1 is a block diagram of a lighting management device (100a) of a lighting system (1000) for managing lighting in an environment, according to an embodiment as disclosed herein. Referring to the FIG. 1, the lighting management device (100a) is part of the lighting system (1000) in the environment. The environment may be for example large spaces such as but not limited to, corporate offices, educational institutions, exhibition areas, tech parks, etc. The lighting system (1000) includes a plurality of illumination sources (110a-N) with each illumination source (110a) is connected to a lighting driver (120a) and the lighting management device (100a), an aggregator (180) and a cloud server (190).

The illumination source (110a) can be for example, a light emitting diode (LED) source, compact fluorescent lamps (CFL), halogen lamps, incandescent bulbs and smart bulbs, organic light-emitting diode (OLEDs) or LED edge-lit panels etc. Each illumination source (110a) in the lighting system (1000) is provided to illuminate a predefined area of the environment. The predefined area of the environment can be for example a cubicle in a corporate office, a work desk in an educational institution, a specific exhibition stall in an exhibition area, etc. The lighting management device (100a) can be for example lighting ballast connected in series with the illumination source (110a) to manage the illumination by limiting an amount of current in the lighting ballast.

In an embodiment, the lighting management device (100a) includes an illumination sensor (130a), an illumination sensor manager (132a), an occupancy sensor (140a), an occupancy sensor manager (142a), a light controller (150a), a lighting driver controller (160a), a memory (162a), a processor (164a) and a communicator (166a). The illumination sensor manager (132a), the occupancy sensor manager (142a), the light controller (150a) and the lighting driver controller (160a) are implemented by processing circuitry such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductors.

In an embodiment, the illumination sensor manager (132a) is configured to determine a lighting condition parameter associated with the environment based on a lighting condition of the environment. The lighting conditions of the environment is determined by the illumination sensor (130a). The illumination sensor (130a) can be for example but not limited to photodiodes, photoresistors, phototransistors, and photovoltaic light sensors. The lighting conditions of the environment can be for example, in an office environment the lighting conditions of a cubicle 1 may be determined based on the lighting conditions of the neighboring cubicles, the ambient natural light available at the cubicle 1, any other source of light such as a table lamp, etc. The lighting condition parameter associated with the environment includes information associated with illumination intensity and illumination color of the environment in current scenario, customization of lighting color temperature, patterns, lighting combinations, etc. The occupancy parameter provides information indicating whether the predefined area in the environment is occupied by a user or if it is vacant.

In an embodiment, the occupancy sensor manager (142a) is configured to determine an occupancy parameter based on an occupancy in the predefined area of the environment. The occupancy in the predefined area of the environment is determined by the occupancy sensor (140a) connected to the occupancy sensor manager (142a). For example, the occupancy sensor (140a) detects when a user is available in the cubicle or not. The occupancy parameter can be for example, a motion-detecting sensor.

In an embodiment, the light controller (150a) is configured to receive the lighting condition parameter, the occupancy parameter and a lighting driver state. The lighting driver state indicates a current lighting condition of the predefined area and a lighting management capability of the lighting driver (120a) associated with the illumination source (110a). The current lighting condition of the predefined area can be for example, dim lit with a illumination intensity and a illumination color at a specific value. The lighting management capability of the lighting driver (120a) of the illumination source (110a) can be for example, a maximum illumination intensity that the lighting driver (120a) can control.

Further, the light controller (150a) is configured to determine an optimum level of illumination intensity and an optimum level of illumination color for the predefined area of the environment based on the received lighting condition parameter, the occupancy parameter and the lighting driver state.

The light controller (150a) determines that the illumination intensity provided by the lighting condition parameter does not meet an illumination intensity threshold and that the illumination color provided by the lighting condition parameter does not meet an illumination color requirement for that environment. Then, the light controller (150a) determines the optimum level of illumination intensity and the optimum level of illumination color for the predefined area of the environment based on at least one of: the lighting condition parameter, the occupancy parameter and the lighting driver state. Here, the illumination intensity threshold is determined based on a minimum illumination required for the predefined area and a maximum illumination provided to the predefined area.

The lighting driver controller (160a) is connected to the light controller (150a) and the lighting driver (120a) of the illumination source (110a). In an embodiment, the lighting driver controller (160a) is configured to manage the lighting conditions of the predefined area of the environment by changing the settings of the lighting driver (120a) of the illumination source (110a), based on the optimum level of illumination intensity and the optimum level of illumination color. Therefore, once the optimum level of illumination intensity and the optimum level of illumination color are determined, the values are configured to the lighting driver (120a) so that the lighting driver (120a) controls the illumination source (110a) to provide the optimum level of illumination intensity and the optimum level of illumination color.

The lighting driver controller (160a) is configured to receive the optimum level of illumination intensity and the optimum level of illumination color for the predefined area from the light controller (150a) and determine multiple parameters associated with the lighting driver (120a) that is connected to the illumination source (110a). Further, the lighting driver controller (160a) is configured to determine whether an occupancy state in the predefined area based on the occupancy parameter is occupied or vacant. On determining that the occupancy state in the predefined area based on the occupancy parameter is occupied, the lighting driver controller (160a) configures the lighting driver (120a) with the determined multiple parameters associated with the lighting driver (120a) and manage the lighting conditions of the predefined area of the environment by modifying the illumination source (110a) using the configured lighting driver (120a). On determining that the occupancy state in the predefined area based on the occupancy parameter is not occupied, the lighting driver controller (160a) switches-off the lighting driver (120a) and in-turn the illumination source (110a).

The memory (162a) is configured to store the multiple parameters associated with the lighting driver (120a), the lighting condition parameter, the occupancy parameter and the lighting driver state at various intervals of time. The memory (162a) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (162a) may, in some examples, be considered a non-transitory storage medium. The term “non-transitory” may indicate that the storage medium is not embodied in a carrier wave or a propagated signal. However, the term “non-transitory” should not be interpreted that the memory (162a) is non-movable. In some examples, the memory (162a) can be configured to store larger amounts of information than its storage space. In certain examples, a non-transitory storage medium may store data that can, over time, change (e.g., in Random Access Memory (RAM) or cache). The memory (162a) can be an internal storage unit or it can be an external storage unit of the lighting management device (100a), a cloud storage, or any other type of external storage.

The processor (164a) is configured to execute instructions stored in the memory (162a). The processor (164a) may be a general-purpose processor, such as a Central Processing Unit (CPU), an Application Processor (AP), or the like, a graphics-only processing unit such as a Graphics Processing Unit (GPU), a Visual Processing Unit (VPU) and the like. The processor (164a) may include multiple cores to execute the instructions. The communicator (140) is configured for communicating internally between hardware components in the lighting management device (100a). Further, the communicator (166a) is configured to facilitate the communication between the lighting management device (100a) and other devices via one or more networks (e.g. Radio technology). The communicator (166a) includes an electronic circuit specific to a standard that enables wired or wireless communication.

At least one of the plurality of modules/components of the light controller (150a) may be implemented through an AI model. A function associated with the AI model may be performed through memory (162a) and the processor (164a). The one or a plurality of processors controls the processing of the input data in accordance with a predefined operating rule or the AI model stored in the non-volatile memory and the volatile memory. The predefined operating rule or artificial intelligence model is provided through training or learning.

Here, being provided through learning means that, by applying a learning process to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

The lighting management device (100a) is also configured to send the lighting condition parameter associated with the environment, the occupancy parameter and the lighting driver state to the aggregator (180) provided in the lighting system (1000). Similarly, the aggregator (180) receives the lighting condition parameter associated with the environment, the occupancy parameter and the lighting driver state associated with all the lighting management devices (100a-N) in the environment. Further, the aggregator (180) sends the aggregated values of each of the lighting condition parameter associated with the environment, the occupancy parameter and the lighting driver state to the cloud server (190).

The cloud server (190) of the lighting system (1000) includes artificial intelligence (AI) based techniques to receive the aggregated values of each of the lighting condition parameter associated with the environment, the occupancy parameter and the lighting driver state for all the lighting management devices (100a-N) in the environment and generate an energy management report. The energy management report indicates an energy consumption pattern in the environment, with specific time intervals when the energy consumption is maximum or the areas with least occupancy rate, etc. Further, the cloud server (190) sends the energy management report to the aggregator (180). The aggregator (180) can then be wirelessly connected to a display system (for example in an IoT environment) where the energy management report may be presented with all the analytics. This can help the users to understand their energy consumption pattern and formulate better energy management strategy.

Furthermore, in a multi-storied building aggregators (180A-N) of multiple floors may be connected to the cloud server (190) and the cloud server (190) may generate a comprehensive energy management report indicating the energy consumption pattern in the different floors of the building.

Although the FIG. 1 shows various hardware components of the lighting management device (100a) but it is to be understood that other embodiments are not limited thereon. In other embodiments, the lighting management device (100a) may include less or more number of components. Further, the labels or names of the components are used only for illustrative purpose and does not limit the scope of the invention. One or more components can be combined together to perform same or substantially similar function.

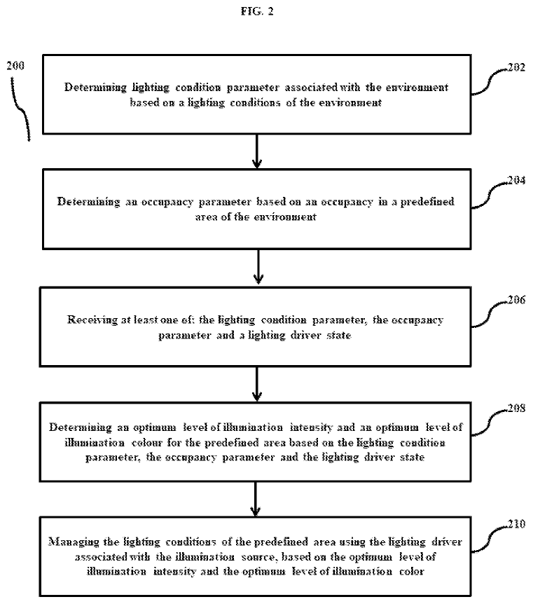

FIG. 2 is a flow chart (200) illustrating a method for managing lighting in an environment by the lighting system (1000), according to an embodiment as disclosed herein.

Referring to the FIG. 2, at step 202, the method includes the lighting management device (100a) determining the lighting condition parameter associated with the environment based on the lighting conditions of the environment. For example, in the lighting management device (100a) described in the FIG. 1, the illumination sensor manager (132a) is configured to determine the lighting condition parameter associated with the environment based on the lighting conditions of the environment.

At step 204, the method includes the lighting management device (100a) determining the occupancy parameter based on an occupancy in a predefined area of the environment. For example, in the lighting management device (100a) described in the FIG. 1, the occupancy sensor manager (142a) is configured to determine the occupancy parameter based on an occupancy in a predefined area of the environment.

At step 206, the method includes the lighting management device (100a) receiving at least one of: the lighting condition parameter, the occupancy parameter and a lighting driver state. For example, in the lighting management device (100a) described in the FIG. 1, the light controller (150a) is configured to receive at least one of: the lighting condition parameter, the occupancy parameter and a lighting driver state.

At step 208, the method includes the lighting management device (100a) determining the optimum level of illumination intensity and an optimum level of illumination colour for the predefined area of the environment based on at least one of: the lighting condition parameter, the occupancy parameter and the lighting driver state. For example, in the lighting management device (100a) described in the FIG. 1, the light controller (150a) is configured to determine the optimum level of illumination intensity and an optimum level of illumination colour for the predefined area of the environment based on at least one of: the lighting condition parameter, the occupancy parameter and the lighting driver state.

At step 210, the method includes the lighting management device (100a) managing the lighting conditions of the predefined area of the environment using the lighting driver (120a) associated with the illumination source (110a), based on the optimum level of illumination intensity and the optimum level of illumination colour. For example, in the lighting management device (100a) described in the FIG. 1, the lighting driver controller (160a) is configured to manage the lighting conditions of the predefined area of the environment using the lighting driver (120a) associated with the illumination source (110a), based on the optimum level of illumination intensity and the optimum level of illumination colour.

The various actions, acts, blocks, steps, or the like in the flow diagram (200) may be performed in the order presented, in a different order or simultaneously. Further, in some embodiments, some of the actions, acts, blocks, steps, or the like may be omitted, added, modified, skipped, or the like without departing from the scope of the invention.

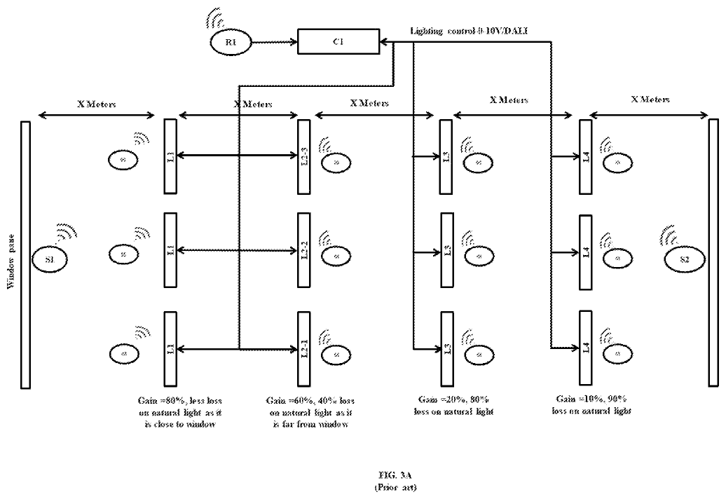

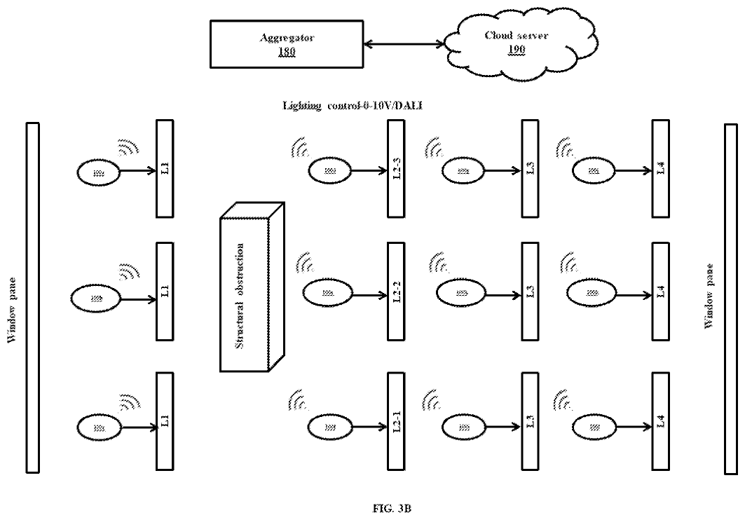

FIG. 3A illustrates the lighting system (1000) for managing the lighting in an office environment, according to prior art.

Referring to the FIG. 3A, consider the conventional lighting system which is based on a single ambient sensor input (installed close to the glass panes i.e., S1, S2—Ambient Light Sensors with wired or wireless connectivity (representation done for wireless in the FIG. 3A)) provided to a control system, based on which the lights or illumination sources are controlled.

The conventional lighting system also includes a wired or wireless receiver (R1), a controller for controlling the Lighting ballasts (C1), say some structural obstruction (01), lights close to the window pane (L1), light away from the window pane and behind a 01 (L2), lighting ballast (L3), lighting ballast (L4) and multiple occupancy sensors for each predefined area such as the cubicle. The conventional lighting system is not a closed loop system and not dynamic (i.e., changing the dimming methodology without hardware change). The data is relayed by the sensor S1 to the controller (C1) and the light management is not done in real time. There are latencies in the transmission of the data, processing of the data based on a number of occupancy sensor installed in the environment and lighting ballasts. The operations of the conventional lighting system are not based on scientific methodology and are mainly based on field conditions and manual work done to collect data during the installation and commissioning process to arrive at the approximate control system inputs as detailed below.

In the FIG. 3A, the ambient sensor input is taken providing the external sunlight intensity, using Lux Meters the manual measurement are done at all/various location to check the loss of the natural light at one time. Further, a loss of natural light is determined using mathematical equations such as,

$$gain = ( 100 - Loss ) is configured to each light ballast . \qquad a$$

$$Loss \% = S 1 Data - Measure Data / S 1 Data . \qquad b$$

The lighting efficiency or saving is calculated based on the gain setting of the lighting system. For example, L2-2 gain is set 40% as measured and calculated for a particular period of the day at 10 AM as provided in table. 1.

TABLE 1

| | | Lighting Dim | Gain |
|---|---|---|---|
| | S1 | Level | % |
| Window Pane ALS Reading | 1000 | | |
| (S1) | | | |
| Ambient Measurement at L1 | 800 | 20% | 80% |
| Ambient Measurement at L2 | 400 | 60% | 40% |
| Ambient Measurement at L3 | 200 | 80% | 20% |
| Ambient Measurement at L4 | 100 | 90% | 10% |

If the same gain setting are used after 4 pm then the values are provided in table. 2.

TABLE 2

| | | Lighting Dim | Gain |
|---|---|---|---|
| | S1 | Level | % |
| Window Pane ALS Reading | 50 | | |
| (S1) | | | |
| Ambient Measurement at L1 | 100 | −100% | 200% |
| Ambient Measurement at L2 | 200 | −300% | 400% |
| Ambient Measurement at L3 | 400 | −700% | 800% |
| Ambient Measurement at L4 | 800 | −1500% | 1600% |

Ideally the Lighting Dim setting at L4 should have been at 20% based on the sun position and natural light availability at the location. However, the light is set at 1500%, since 1500% is not a practical value, considering 100% as max; 80% loss of energy. The energy loss is huge for the said period. Though the lighting system is efficient in energy saving for half a day, there is huge loss in the second half of the day. The conventional lighting system also does not take care of the position of the sun and the lighting conditions at various daytime.

The conventional lighting system also does not take into account the artificial light that might affect the predefined area. For example, if L2-1 is ON at 80%, then L2-2 would also receive a x % of the light at the location. The sensor S1 would fail to measure this condition and hence x % of L2-2 would be higher than required, resulting in the loss the energy by x %. X cannot be defined, as the variable governing the light illumination would depend on the type of work area, color of the desk and walls (Light loss due to the absorption by static material in the area).

Therefore, the conventional lighting systems are not able to address the above-mentioned problems and hence there is a requirement for dynamic and closed loop lighting system with measurement of the ambient light at the work place level to perform an optimum level management of the illumination and power saving is needed.

The conventional lighting systems are not Human Centric Lighting, as the conventional lighting systems are not able to measure the required parameter like Red, Green, Blue and IR intensities to control the lighting condition at the work place level and do the required adjust to the illumination. Therefore, the conventional lighting systems are not efficient in energy management and not accurate in providing the saving of the lighting system.

FIG. 3B illustrates the lighting system (1000) for managing the lighting in the office environment, according to an embodiment as disclosed herein. Referring to the FIG. 3B, in conjunction with the FIG. 3A, the proposed lighting system (1000) includes lights close to the window pane (L1), light away from the window pane and behind the structural obstruction (L2), lighting ballast (L3), lighting ballast (L4). However, in the proposed lighting system (1000) each illumination source is connected to the lighting driver and the corresponding lighting management devices (100a-1). Each of the lighting management devices (100a-1) are wirelessly connected to the aggregator (180) and the aggregator (180) is connected to the cloud server (190). Each of these lighting management devices (100a-1) includes illumination sensors and occupancy sensors along with the light controller (150a) and the lighting driver controller (160a). Therefore, the lighting management devices (100a-1) are comprehensive devices which unlike the occupancy sensors used in the existing lighting management systems.

The light controllers (150a-1) in each of the lighting management devices (100a-1) are configured to accurately sense the illumination intensity and the sense illumination color associated with the illumination source in the predefined space which is illuminated with artificial light and day light.

The light controllers (150a-1) takes input of the light condition and determines the optimum level of the illumination intensity and the illumination color, based on the inputs received from the various parameter from the multiple sensors which inbuilt into the lighting management system (1000). The parameter includes light color intensity for Red, Green, Blue and infrared radiation (IR), Passive Infrared (PIR) and ambient light intensity, the light controllers (150a-1) provide the best work environment and illumination requirements in the particular area of for example but not limited to approximately 70 sqft.

The light controllers (150a-1) determine the optimal level of the illumination intensity and the illumination color, and governs the lighting driver of the corresponding illumination source. Therefore, the proposed lighting system (1000) is a closed loop system established by the lighting management devices (100a-1) to control the illumination at the optimum level as determined by the light controllers (150a-1) without flickers and disturbance. The light controllers (150a-1) also determine the lighting driver capabilities like whether the driver is dimmable, if dimmable what dimming methodology is applied such as for example, e.g. Digital Addressable Lighting Interface (DALI) or 0V to 10V and adjust the light controllers (150a-1) to take the necessary inputs only.

The lighting system (1000) includes inbuilt wireless communication protocol for configuration of the lighting system (1000) to adjust the parameters of the lighting system (1000) based on user requirements. The data as collected from the lighting management devices (100a-1) is sent to the cloud server (190) via the aggregator (180) wirelessly using any existing communication protocol such as for example but not limited to: Bluetooth Mesh protocol. Based on the data, the data analysis is done to determine the precise saving of the energy which is provided in the energy management report.

The light controllers (150a-1) use the below mentioned definitions as follows:

Current illumination setting=((((Required_Illumination−measured Illumination value)*100)/MaxIlluminationRequired)+Last Illumination Settings);

Required Illumination and Max_Illumination are configurable parameter;

Required illumination is the minimum brightness requirements that is constant in the particular area and also the color of the light that needs to be achieved. Max illumination is the maximum brightness to which the sensors and the light controllers (150a-1) should be active for. When the daylight illumination is way higher, the light controllers (150a-1) would not be able to control the light directly, but indirect methodologies of using shades to control the direct light and provide optimum condition. “Last Illumination Settings” is the feedback from the lighting driver on the current setting the driver is operating on.

“Measured Illumination value” is the sensor input for all the parameters.

```
If (Current Occupancy Status = Occupied)
{
  Configure the Lighting driver with the current illumination settings
}
else{
  Switch of the Lighting Driver
}
```

The advantages of the proposed lighting system (1000) include the below:
c. Real time control of the lighting in the environment
d. Saves more energy in the building management system as the proposed lighting system (1000) is very dynamic
e. Provides better work environment for the users
f. Takes care of individual work spaces or predefined spaces rather a common area

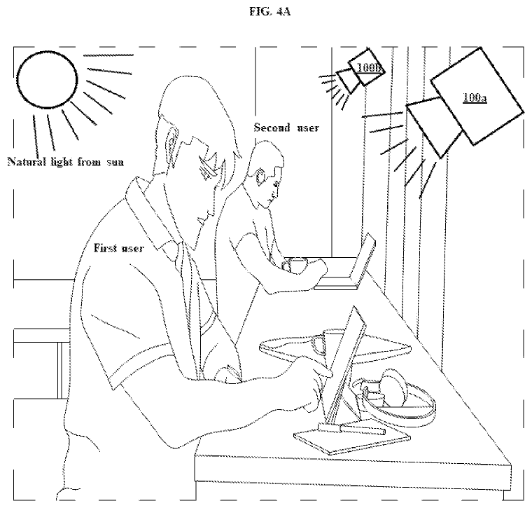

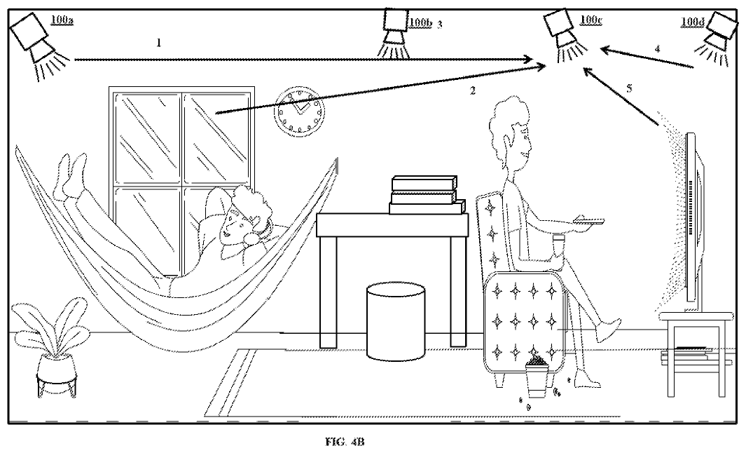

FIG. 4A is an example illustrating the lighting system for managing the lighting in a work area, according to an embodiment as disclosed herein.

Referring to the FIG. 4A, consider the work area comprising the first lighting management device (100a) illuminating the work area of a first user and the second lighting management device (100b) illuminating the work area of a second user. Also, the users are seated close to the window pane and hence there is ambient sunlight present in the work area. Therefore, the first lighting management device (100a) determines the optimum level of the light intensity and the light color to be provided to the first user by considering the sunlight and the light from the second lighting management device (100b). Then, the first lighting management device (100a) controls the light driver (120a) of the first illumination source (110a) to provide the determined optimum level of the light intensity and the light color to the first user. Similarly, the second lighting management device (100b) determines the optimum level of the light intensity and the light color to be provided to the second user by considering the sunlight and the light from the first lighting management device (100a). Then, the second lighting management device (100b) controls the light driver (120b) of the second illumination source (110b) to provide the determined optimum level of the light intensity and the light color to the second user.

Consider a scenario where the first user vacates the work area. Then, the first lighting management device (100a) determines that the predefined area associated with the first lighting management device (100a) is vacant and automatically switches-OFF the first illumination source (110a). When the first user comes back and re-occupies the predefined area associated with the first lighting management device (100a), then the first lighting management device (100a) determines the presence of the user and switches-OFF the first illumination source (110a). Now consider that the second user has vacated the work area and the second illumination source (110b) is switched-OFF. In such a scenario, the first lighting management device (100a) determines the optimum level of the light intensity and the light color to be provided to the first user by considering the sunlight alone. In this scenario, the optimum level of the light intensity and the light color to be provided to the first user is different than when the second user has occupied the work space.

FIG. 4B is an example illustrating the lighting system (1000) for managing the lighting in a home area, according to an embodiment as disclosed herein.

Referring to the FIG. 4B, consider the home area with multiple illumination sources each with a lighting management device i.e., the first lighting management device (100a), the second illumination source (110b), a third lighting management device (100c) and a fourth lighting management device (100d). Each of the multiple illumination sources are provided to illuminate the predefined area in the home. Consider that the second illumination source (110b) is illuminating a study table and that the second lighting management device (100b) determines that the user who was sitting at the study table has moved to watch the TV. Therefore, the second lighting management device (100b) automatically switches-OFF the second illumination source (110b).

When the third lighting management device (100c) determines that the illumination area associated with the third illumination source (110c) has been occupied by the user, the third lighting management device (100c) determines the optimum level of the light intensity and the light color to be provided by the third illumination source (110c). Therefore, the third lighting management device (100c) determines the optimum level of the light intensity and the light color based on the illumination from (1) the first lighting management device (100a), (2) the natural light from the window pane, (3) the second illumination source (110b) is switched-OFF, (4) the fourth lighting management device (100d) and (5) also the illumination from the TV unit.

Therefore, unlike to the conventional methods and systems, in the proposed lighting system (1000) automatically determines the occupancy of the predefined area in real-time and determines the optimal level of the light intensity and the light color to be provided in the predefined area at the given point of time. Therefore, the proposed method is very dynamic and takes into consideration multiple factors for determining the optimal level of the light intensity and the light color which makes the systems highly efficient and comprehensive.

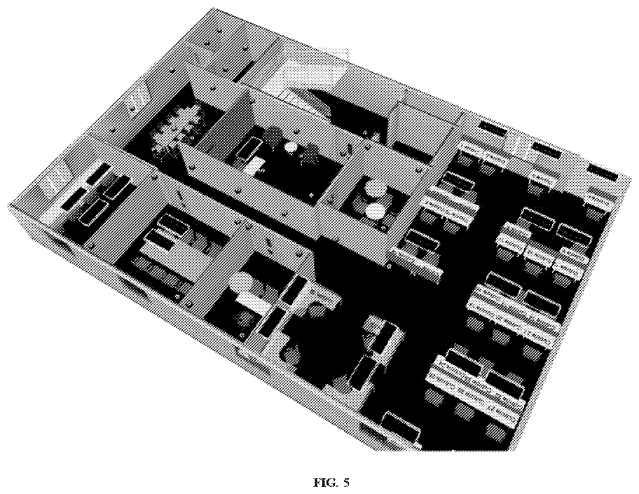

FIG. 5 is an example illustrating the lighting system (1000) for managing the lighting in a large corporate office with multiple cubicles, according to an embodiment as disclosed herein.

Referring to the FIG. 5, consider the example lighting system (1000) for managing the lighting in the large corporate office with multiple cubicles.

Consider that a first cubicle is occupied and the occupancy status is detected by a first lighting management device (100a) as shown in the FIG. 5. The illumination source (110a) above the first cubicle and a second cubicle are set to ON based on the lighting condition parameter associated with the environment. The lighting condition parameter associated with the environment is determined based on the following factors:
1. Illumination due to light through the window
2. Illumination due to the glass window panel on a right side of the first cubicle.

Since the illumination source (110a) above the first cubicle and the second cubicle are set to ON, there is light dispersion in a third cubicle. Therefore, when the third cubicle is occupied then a second lighting management device (100b) takes into account a current status of the light at the third cubicle in determining the lighting condition parameter associated with the environment. The lighting condition parameter associated with the third cubicle is affected by the following factors:
1. Illumination due to the illumination source (110a) above the first cubicle
2. Illumination due to light through the window
3. Illumination due to the glass window panel on the right side

The closed loop of the lighting system (1000) is established as due to the light ON of the second cubicle there is light dispersion on the first cubicle. Then, the first lighting management device (100a) again adjusts the light intensity based on the feedback from the illumination sensor (130a). The system feedback takes into account error factor and optimum level is set for the illumination source (110a). Therefore, in the proposed method the light management happens continuously every time a user in a cubicle vacates their seat, the same is taken into consideration the illumination source (110a) of the concerned cubicle is switched-off. Therefore, the proposed lighting system (1000) is very dynamic and every change in occupancy or lighting system is reflected accordingly to modify the lighting in the environment thereby saving a large amount of energy.

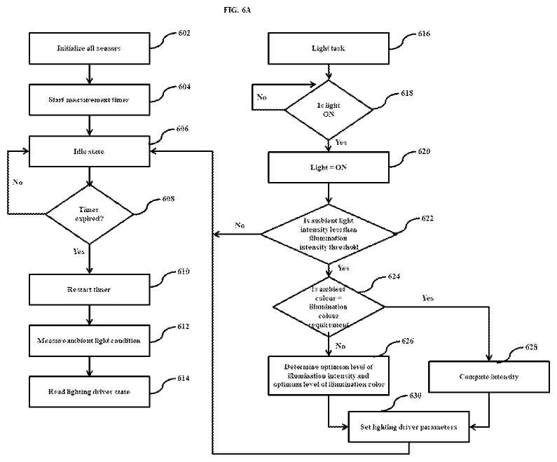

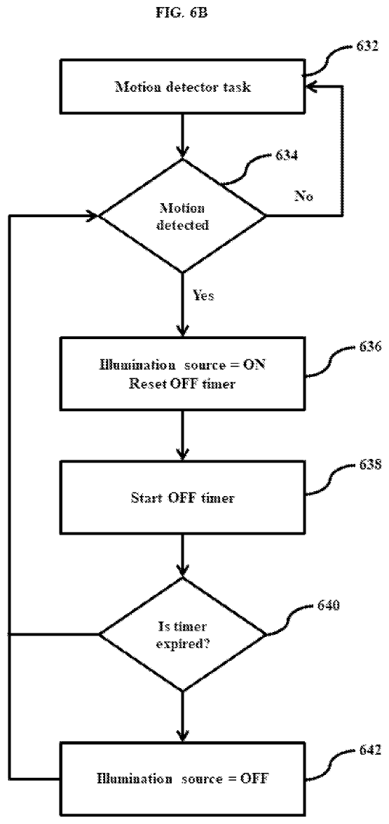

FIG. 6A-6B are flow charts illustrating step-by-step process for managing the lighting in the environment by the lighting system, according to an embodiment as disclosed herein.

Referring to the FIG. 6A, at step 602, the method for managing the lighting in the environment by the lighting system (1000) includes initializing all the sensors (130a-N and 140a-N) and at step 604, the measurement timer is started. At step 606, the timer is in idle state.

At step 608, the method includes determining whether the timer is expired or not.

At step 610, in response to determining that the timer is expired, restarting the timer and in response to determining that the timer is not expired, the method loops back to the step 606.

At step 612, the method includes measuring the ambient light condition by the lighting management device (100a) and at step 614, the lighting management device (100a) reads the lighting driver state.

At step 616, the light task is initiated. At step 618, the method includes determining whether the light is ON.

At step 620, the method determines that the light is ON and at step 622, the method includes the lighting management device (100a) determining whether the ambient light intensity is less than the illumination intensity threshold.

At step 624, in response to determining that the ambient light intensity is less than the illumination intensity threshold, the method includes the lighting management device (100a) determining if the ambient color is same as the illumination color requirement and in response to determining that the ambient light intensity is greater than the illumination intensity threshold, the method loops to the step 606.

At step 626, in response to determining that the ambient color is same as the illumination color requirement the lighting management device (100a) determines the optimum level of illumination intensity and the optimum level of illumination color.

At step 628, in response to determining that the ambient color is not same as the illumination color requirement the lighting management device (100a) determines the optimum level of illumination intensity. At step 630, the lighting management device (100a) sets the lighting driver parameters.

Referring to the FIG. 6B, at step 632, the lighting management device (100a) initiates the motion detection task and at step 634, the lighting management device (100a) determines whether the motion is detected or not. At step 636, the lighting management device (100a), in response to detecting the motion, switches ON the illumination source (110a) and also resets the OFF timer. In response to not detecting the motion, the lighting management device (100a) loops back to the step 632.

Further, at step 638, the lighting management device (100a), starts the OFF timer. At step 640, the lighting management device (100a) determines whether the timer is expired. At step 642, in response to determining that the timer is expired, the lighting management device (100a) switches OFF the illumination source (110a). In response to determining that the timer is not expired, the lighting management device (100a) loops back to the step 634.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the claims as described herein.

We claim:

1. A lighting system (1000) for managing lighting in an environment, wherein the lighting system (1000) comprises:
a plurality of illumination sources (110a-N) in the environment, wherein each illumination source comprises a lighting driver (120a);
a lighting management device (100a) of a plurality of lighting management devices (100a-N) connected to an illumination source (110a) of the plurality of illumination sources (110a-N) through the lighting driver (120a), wherein the lighting management device (100a) comprises:
at least one illumination sensor manager (132a) configured to determine a lighting condition parameter associated with the environment based on a lighting condition of the environment, wherein the lighting conditions of the environment is determined by at least one illumination sensor (130a) connected to the at least one illumination sensor manager (132a);
at least one occupancy sensor manager (142a) configured to determine an occupancy parameter based on an occupancy in a predefined area of the environment, wherein the occupancy in the predefined area of the environment is determined by at least one occupancy sensor (140a) connected to the at least one occupancy sensor manager (142a);
a light controller (150a) configured to receive at least one of: the lighting condition parameter, the occupancy parameter and a lighting driver state, and determine an optimum level of illumination intensity and an optimum level of illumination color for the predefined area of the environment based on at least one of: the lighting condition parameter, the occupancy parameter and the lighting driver state, wherein the lighting driver state indicates at least one of a current lighting condition of the predefined area and a lighting management capability of the lighting (120a) associated with the illumination source (110a); and
a lighting driver controller (160a) configured to manage the lighting conditions of the predefined area of the environment using the lighting driver (120a) associated with the illumination source (110a), based on the optimum level of illumination intensity and the optimum level of illumination color, wherein the lighting driver controller (160a) is connected to the light controller (150a) and the lighting driver (120a) associated with the illumination source (110a).

2. The lighting system (1000) as claimed in claim 1, wherein at least one illumination sensor manager (132a) is configured to determine the lighting condition parameter associated with the environment based on the lighting conditions of the environment comprises:
determine at least one of: illumination intensity and illumination color in the predefined area of the environment based on the lighting conditions, wherein the predefined area of the environment is illuminated by at least one of: the illumination source (110a) associated with the predefined area, at least one illumination source (110b) associated with at least one neighboring area of the predefined area and natural light; and
determine the lighting condition parameter using at least one of: the illumination intensity and the illumination color in the predefined area of the environment.

3. The lighting system (1000) as claimed in claim 1, wherein the light controller (150a) is configured to determine the optimum level of illumination intensity and the optimum level of illumination color for the predefined area of the environment based on at least one of: the lighting condition parameter, the occupancy parameter and the lighting driver state comprises:
determine that the illumination intensity of the lighting condition parameter does not meet an illumination intensity threshold, wherein the illumination intensity threshold is determined based on a minimum illumination required for the predefined area and a maximum illumination provided to the predefined area;
determine that the illumination color of the lighting condition parameter does not meet an illumination color requirement; and
determine the optimum level of illumination intensity and the optimum level of illumination color for the predefined area of the environment based on at least one of: the lighting condition parameter, the occupancy parameter and the lighting driver state.

4. The lighting system (1000) as claimed in claim 1, wherein the lighting driver controller (160a) configured to manage the lighting conditions of the predefined area of the environment using the lighting driver (120a) associated with the illumination source (110a), based on the optimum level of illumination intensity and the optimum level of illumination color comprises:
receive the optimum level of illumination intensity and the optimum level of illumination color for the predefined area;
determine a plurality of parameters associated with the lighting driver (120a) that is connected to the illumination source (110a);
determine whether an occupancy state in the predefined area based on the occupancy parameter is occupied;
perform one of:
configure the lighting driver (120a) with the determined plurality of parameters associated with the lighting driver (120a) and manage the lighting conditions of the predefined area of the environment by modifying the illumination source (110a) using the configured lighting driver (120a), in response to determining that the occupancy state in the predefined area based on the occupancy parameter is occupied, and
switch-off the lighting driver (120a), in response to determining that the occupancy state in the predefined area based on the occupancy parameter is not occupied.

5. The lighting system (1000) as claimed in claim 1, wherein the lighting system (1000) further comprises an aggregator (180) configured to:
send at least one of: the lighting condition parameter associated with the environment, the occupancy parameter and the lighting driver (120a) state to a cloud server (190);
receive energy management report from the cloud server (190), wherein the energy management report is generated by the cloud server (190) based on at least one of: the lighting condition parameter associated with the environment, the occupancy parameter and the lighting driver state.

6. The lighting system (1000) as claimed in claim 1, wherein the lighting condition parameter associated with the environment comprises information associated with illumination intensity and illumination color of the environment and the occupancy parameter comprises information indicating whether the predefined area in the environment is occupied or vacant.

7. A method for managing lighting in an environment by a lighting system (1000), wherein the method comprises:
determining, by a lighting management device (100a) of a plurality of lighting management devices (100a-N) of the lighting system (1000), lighting condition parameter associated with the environment based on a lighting conditions of the environment;
determining, by the lighting management device (100a), an occupancy parameter based on an occupancy in a predefined area of the environment;
receiving, by the lighting management device (100a), at least one of: the lighting condition parameter, the occupancy parameter and a lighting driver state, wherein the lighting driver state indicates at least one of a current lighting condition of the predefined area and a lighting management capability of a lighting driver (120a) associated with an illumination source (110a);
determining, by the lighting management device (100a), an optimum level of illumination intensity and an optimum level of illumination color for the predefined area of the environment based on at least one of: the lighting condition parameter, the occupancy parameter and the lighting driver state; and
managing, by the lighting management device (100a), the lighting conditions of the predefined area of the environment using the lighting driver (120a) associated with the illumination source (110a), based on the optimum level of illumination intensity and the optimum level of illumination color.

8. The method as claimed in claim 7, wherein determining, by the lighting management device (100a), the lighting condition parameter associated with the environment based on the lighting conditions of the environment comprises:
determining, by the lighting management device (100a), at least one of: illumination intensity and illumination color in the predefined area of the environment based on the lighting conditions, wherein the predefined area of the environment is illuminated by at least one of: the illumination source associated with the predefined area, at least one illumination source associated with at least one neighboring area of the predefined area and natural light; and
determining, by the lighting management device (100a), the lighting condition parameter using at least one of: the illumination intensity and the illumination color in the predefined area of the environment.

9. The method as claimed in claim 7, wherein determining, by the lighting management device (100a), the optimum level of illumination intensity and the optimum level of illumination color for the predefined area of the environment based on at least one of: the lighting condition parameter, the occupancy parameter and the lighting driver state comprises:
determining, by the lighting management device (100a), that the illumination intensity of the lighting condition parameter does not meet an illumination intensity threshold, wherein the illumination intensity threshold is determined based on a minimum illumination required for the predefined area and a maximum illumination provided to the predefined area;
determining, by the lighting management device (100a), that the illumination color of the lighting condition parameter does not meet an illumination color requirement; and
determining, by the lighting management device (100a), the optimum level of illumination intensity and the optimum level of illumination color for the predefined area of the environment based on at least one of: the lighting condition parameter, the occupancy parameter and the lighting driver state.

10. The method as claimed in claim 7, wherein managing, by the lighting management device (100a), the lighting conditions of the predefined area of the environment using the lighting driver (120a) associated with the illumination source (110a), based on the optimum level of illumination intensity and the optimum level of illumination color comprises:
receiving, by the lighting management device (100a), the optimum level of illumination intensity and the optimum level of illumination color for the predefined area;
determining, by the lighting management device (100a), a plurality of parameters associated with the lighting driver (120a) that is connected to the illumination source (110a);
determining, by the lighting management device (100a), whether an occupancy state in the predefined area based on the occupancy parameter is occupied;
performing, by the lighting management device (100a), one of:
configure the lighting driver (120a) with the determined plurality of parameters associated with the lighting driver (120a) and manage the lighting conditions of the predefined area of the environment by modifying the illumination source (110a) using the configured lighting driver (120a), in response to determining that the occupancy state in the predefined area based on the occupancy parameter is occupied, and
switch of the lighting driver (120a), in response to determining that the occupancy state in the predefined area based on the occupancy parameter is not occupied.

11. The method as claimed in claim 7, further comprises:
sending, by an aggregator (180) of the lighting system (1000), at least one of: the lighting condition parameter associated with the environment, the occupancy parameter and the lighting driver state to a cloud server (190);
receiving, by the aggregator, energy management report from the cloud server (190), wherein the energy management report is generated by the cloud server (190) based on at least one of: the lighting condition parameter associated with the environment, the occupancy parameter and the lighting driver state.

12. The method as claimed in claim 7, wherein the lighting condition parameter associated with the environment comprises information associated with illumination intensity and illumination color of the environment and the occupancy parameter comprises information indicating whether the predefined area in the environment is occupied or vacant.
